(19) United States
(12) Patent Application Publication
(10) Pub. No.: US 2017/0061394 A1
(43) Pub. Date: Mar. 2, 2017

(54) Method and Apparatus to Automatically Facilitate Changes to a Fresh Produce Display

(71) Applicant: Wal-Mart Stores, Inc., Bentonville, AR (US)

(72) Inventors: Donald R. High, Noel, MO (US); Chandrashekar Natarajan, San Ramon, CA (US)

(21) Appl. No.: 15/253,234

(22) Filed: Aug. 31, 2016

Related U.S. Application Data
(60) Provisional application No. 62/212,974, filed on Sep. 1, 2015.

(51) Int. Cl. G06Q 10/10; B64C 39/02; H04W 4/02

(52) U.S. Cl. CPC G06Q 10/1097; H04W 4/02; B64C 39/024; B64C 2201/12

(57) ABSTRACT

A control circuit is configured to use monitored-crop information from a crop-monitoring airborne drone to automatically facilitate changes to the fresh produce display of one or more retail shopping facilities. The crop-monitoring information can include, for example, one or more of information regarding crop maturity, weed infestation, insect infestation, a plant disease indicator, parched conditions, irrigation status, land-area yield, temperature conditions, conflicting neighboring crops, and post-harvest waste. Using such crop-monitoring information the control circuit can assess at least the likelihood that a particular crop of a particular produce item will be available for display in the fresh produce display by a particular date, in a particular volume, and having a particular quality. This same information can also serve to determine a distance that such crops must travel to reach the retail shopping facility and hence whether the produce items are fairly characterized as being locally sourced.

### CROSS-REFERENCE TO RELATED APPLICATION

This application claims the benefit of U.S. Provisional Application No. 62/212,974, filed Sep. 1, 2015, which is incorporated herein by reference in its entirety.

### TECHNICAL FIELD

These teachings relate generally to fresh produce displays.

### BACKGROUND

Many modern supermarkets (whether those supermarkets are stand-alone facilities or incorporated into a larger retail setting) include a fresh produce display. A fresh produce display serves to present various fresh fruits and vegetables that are being offered for retail purchase by visitors to the supermarket. Fresh produce typically has a limited shelf life beyond which the offerings can spoil or otherwise become unsatisfactory to the consumer. Matching supply to demand is therefore particularly important. Pricing and promotional tie-ins are one way to help strike that balance.

Unfortunately, depending upon the time of year and many other factors, various fruits and vegetables may be shipped to a particular supermarket over a great range of distances. In some cases, a good local harvest makes it possible to offer and promote the availability of locally-produced crops. In other cases the produce may need to be shipped in from a considerable distance in order to ensure an adequate supply, therefore complicating both timing and availability concerns. Further complicating the management of a fresh produce display is a lack of timely information regarding the timing, quality, and volume for each harvest for each of a plurality of farms.

### BRIEF DESCRIPTION OF THE DRAWINGS

The above needs are at least partially met through provision of the method and apparatus to automatically facilitate changes to a fresh produce display described in the following detailed description, particularly when studied in conjunction with the drawings, wherein:

FIG. 1 comprises a flow diagram as configured in accordance with various embodiments of these teachings;

FIG. 2 comprises a block diagram as configured in accordance with various embodiments of these teachings;

FIG. 3 comprises a block diagram as configured in accordance with various embodiments of these teachings; and

FIG. 4 comprises a top plan schematic view as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a control circuit is configured to use monitored-crop information from a crop-monitoring airborne drone to automatically facilitate changes to the fresh produce display of one or more retail shopping facilities. The crop-monitoring information can include, for example, one or more of information regarding crop maturity, weed infestation, insect infestation, a plant disease indicator, parched conditions, irrigation status, land-area yield, temperature conditions, conflicting neighboring crops, and post-harvest waste. Using such crop-monitoring information the control circuit can assess at least the likelihood that a particular crop of a particular produce item will be available for display in the fresh produce display by a particular date, in a particular volume, and having a particular quality. This same information can also serve to determine a distance that such crops must travel to reach the retail shopping facility and hence whether the produce items are fairly characterized as being locally sourced.

These teachings are highly flexible in practice and will accommodate a variety of automatically facilitated changes to a fresh produce display. By one example, the changes can comprise scheduled changes to pricing for one or more fresh produce items. As another example the changes can comprise scheduled changes to non-pricing promotional content in the fresh produce display. And as yet another example, the changes can comprise at least one of introducing and/or removing non-produce product tie-ends.

These teachings can be leveraged in other ways as well. As one example in these regards, the control circuit can be configured to use the monitored-crop information from the crop-monitoring airborne drone to automatically facilitate routing of produce from a distribution center or from another retail shopping facility to the retail shopping facility having the fresh produce display at issue.

So configured, the many vagaries of farming can at least be better understood in ways that help better coordinate and schedule the eventual offering of harvested produce in a fresh produce display to thereby better serve the needs of both the retailer and the consumer. It should be noted that these teachings do not have, as a core goal, helping or advising the farmer to better their own results. These teachings do not require, for example, providing any of the crop-monitoring information to the farmer. That said, if desired, sharing such information with the farmer can be accommodated.

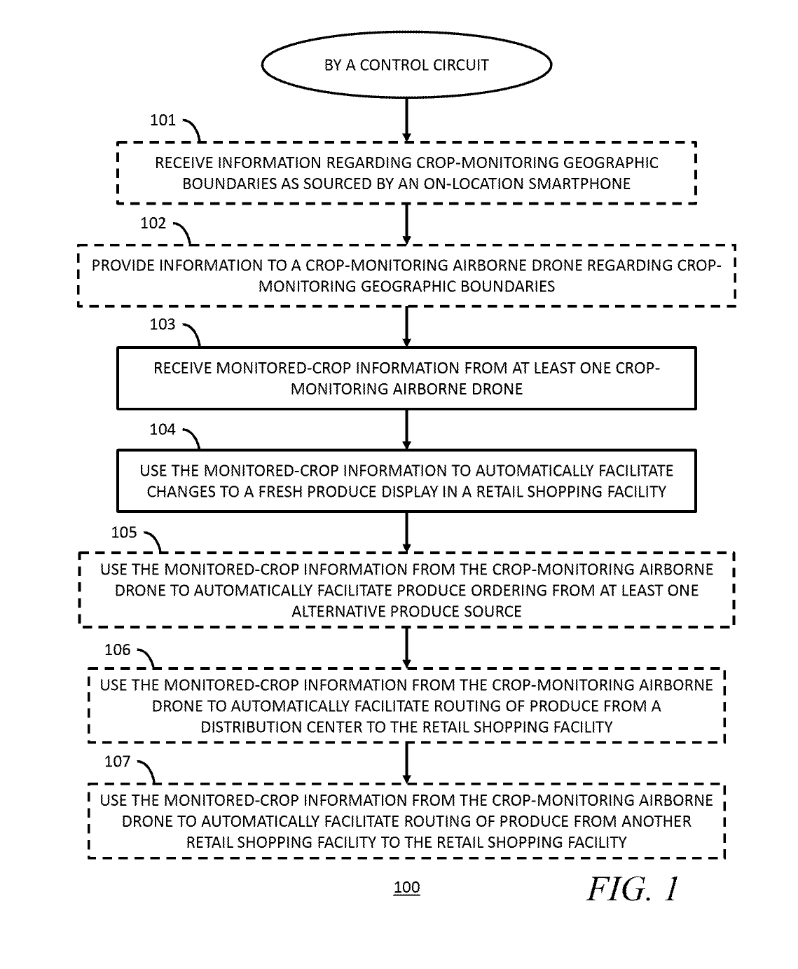

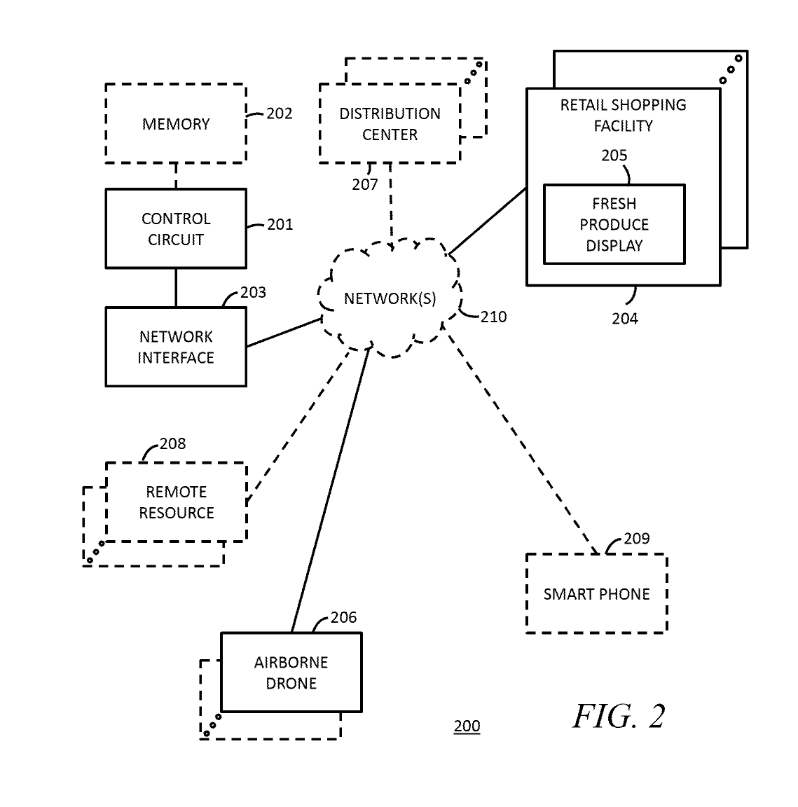

These and other benefits may become clearer upon making a thorough review and study of the following detailed description. Referring now to the drawings, and in particular to FIG. 1, an illustrative process 100 that is compatible with many of these teachings will now be presented. For the sake of an illustrative example it will be presumed here that a control circuit of choice carries out the actions, steps, and/or functions of this process 100. FIG. 2 provides an illustrative example in these regards.

In this particular example, the enabling apparatus 200 includes such a control circuit 201. Being a “circuit,” the control circuit 201 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 201 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 201 is configured (for example, by using corresponding programming as will be well understood by those skilled in the art) to carry out one or more of the steps, actions, and/or functions described herein.

By one optional approach the control circuit 201 operably couples to a memory 202. This memory 202 may be integral to the control circuit 201 or can be physically discrete (in whole or in part) from the control circuit 201 as desired. This memory 202 can also be local with respect to the control circuit 201 (where, for example, both share a common circuit board, chassis, power supply, and/or housing) or can be partially or wholly remote with respect to the control circuit 201 (where, for example, the memory 202 is physically located in another facility, metropolitan area, or even country as compared to the control circuit 201).

In addition to the aforementioned crop-monitoring information, this memory 202 can serve, for example, to non-transitorily store the computer instructions that, when executed by the control circuit 201, cause the control circuit 201 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

In this example the control circuit 201 also operably couples to a network interface 203. So configured the control circuit 201 can communicate with other elements (both within the apparatus 200 and external thereto) via the network interface 203. Network interfaces, including both wireless and non-wireless platforms, are well understood in the art and require no particular elaboration here.

The enabling apparatus 200 also includes at least one retail shopping facility 204. Each retail shopping facility 204 comprises a retail sales facility or any other type of bricks-and-mortar (i.e., physical) facility in which products are physically displayed and offered for sale to customers who physically visit the facility. The shopping facility may include one or more of sales floor areas, checkout locations (i.e., point of sale (POS) locations), customer service areas other than checkout locations (such as service areas to handle returns), parking locations, entrance and exit areas, stock room areas, stock receiving areas, hallway areas, common areas shared by merchants, and so on. The facility may be any size of format facility, and may include products from one or more merchants. For example, a facility may be a single store operated by one merchant or may be a collection of stores covering multiple merchants such as a mall.

In any event, in this example the retail shopping facility 204 includes a fresh produce display 205. This fresh produce display 205 presents a variety of fresh fruits and vegetables that are offered for retail sale to visiting customers. In many cases the fresh produce display 205 includes one or more items of non-pricing promotional content. Examples in these regards include posters or other images of serving suggestions for one or more items of produce, nutritional information for one or more items of produce, content regarding geographic sources of one or more items of produce, and so forth.

This example also illustrates the use of one or more airborne drones 206. As used herein, the expression “airborne” is not meant to refer to a current flying status of the drone but instead serves to characterize the drone 206 as being a drone that is capable of controlled flight. This is to distinguish a flying drone from a terrestrial drone. Airborne drones are a well understood though currently growing field of endeavor. As the present teachings are not overly sensitive to any particular selections in these regards, no detailed discussion regarding the general design of airborne drones is provided here.

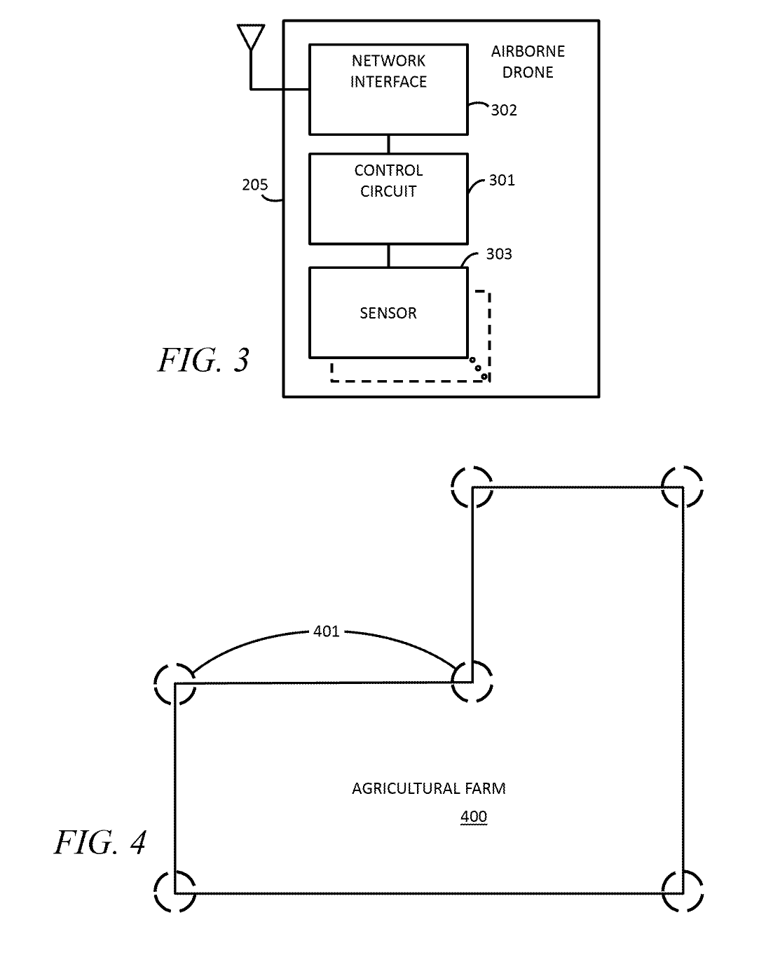

That said, and referring momentarily to FIG. 3, in this illustrative example the airborne drone 206 is presumed to itself have a control circuit 301 that can communicate with the aforementioned control circuit 201 via an on-board network interface 302. The airborne drone 206 also includes one or more on-board sensors 303 that sense one or more conditions or circumstances that the airborne drone 206 and/or the control circuit 201 can employ to develop crop-monitoring information of interest. Examples in these regards include but are not limited to thermometers, humidistats, video cameras having sensitivity to various light spectra of interest, thermal sensors, and so forth.

Referring again to FIG. 2, these teachings will also accommodate the presence of one or more distribution centers 207. A distribution center 207 will be physically and geographically separated from the retail shopping facility 204 and can serve, for example, as an intermediary warehouse from which fresh produce is shipped to various ones of the retail shopping facilities 204. Similarly, these teachings will accommodate, in lieu of the foregoing or in combination therewith, the presence of one or more remote resources 208. As one example of a remote resource, the remote resource 208 can comprise another source for produce other than a retail shopping facility 204 or a distribution center 207. As another example of a remote resource, the remote resource 208 can comprise a processing facility to receive some or all of the sensor information developed by the airborne drone 206 to thereby develop some or all of the crop-monitoring information utilized by the control circuit 201 per these teachings.

By one optional approach these teachings will also accommodate one or more smart phones 209 where the term “smart phone” will be understood to refer to a variety of modern communications devices including cellular telephones as well as pad/tablet-styled computers. Examples regarding how a smart phone 209 can serve in the present regards appear below.

These various components and elements can communicate with one another in this illustrative example via one or more intervening networks 210. This network or networks can comprise any of a variety of wireless and/or non-wireless platforms as are known in the art. By one approach, for example, this network 210 comprises, at least in part, the Internet. In such a case, the aforementioned network interface 203 then comprises, at least in part, an Internet interface.

With continued reference to FIGS. 1 and 2, at optional block 101 the control circuit 201 receives information regarding crop-monitoring geographic boundaries as sourced by an on-location smart phone 209. FIG. 4 presents an illustrative example in these regards. In this example the agricultural farm 400 has an L-shaped layout when viewed from above. The farmer intends to plant this particular area with the same item (such as a particular variety of carrot or potato).

In this example the farmer's smart phone 209 is equipped with a simple smart phone app that permits the farmer to draw or select a simple top view diagram of the area in question and to then physically proceed to each of the corners of that field and assert a button on the smart phone 209 to instruct the smart phone 209 to correlate that particular location of the agricultural farm 400 with specific global positioning system-derived coordinates. When all of the corners are correlated in this manner, the information is communicated from the smart phone 209 to the control circuit 201 (or to a pre-arranged remote resource 208). So configured the control circuit 201 can be informed regarding the size, shape, and dimensions of a particular field as well as, if desired, the particular crop or crops that are to be grown or which are growing in that field.

Referring again to FIGS. 1 and 2, at optional block 102 the control circuit 201 provides information to one or more crop-monitoring airborne drones 206 regarding the crop-monitoring geographic boundaries of the field to be monitored by that particular drone 206. For example, when the geographic boundaries of the field are determined as described above, those corner coordinates can be provided to the crop-monitoring airborne drone 206 to thereby facilitate the latter determining the boundaries of its monitoring range.

These teachings will of course accommodate other approaches in these regards. For example, by one approach a human operator can program the crop-monitoring airborne drone 206 on-site using information gleaned via other processes. By another approach energy-meeting beacons or visually-unique markers can be placed at each corner that can be detected by the airborne drone 206 to thereby determine its boundaries.

In any event, at block 103 the control circuit 201 receives monitored-crop information from the at least one crop-monitoring airborne drone 206. This information can be received as regularly or as infrequently as may be desired or as may be appropriate in view of the present application setting. These teachings will accommodate having the crop-monitoring airborne drone 206 push this information to the control circuit 201, or having the control circuit 201 pull the information from the crop-monitoring airborne drone 206 (using, for example, a polling protocol), or using both of these approaches as appropriate.

The monitored-crop information itself can vary with the application setting and/or the needs of the retailer. It is also possible for the specific items of information to very with respect to a time of year, a particular relative time during the planting, maturation, and/or harvesting of a particular crop, and so forth. Specific items of monitored crop information that can serve in these regards include crop maturity information, weed infestation information, insect infestation information, a plant disease indicator, parched conditions information, irrigation status information, land-area yield information, temperature conditions information, conflicting neighboring crops information, and post-harvest waste information. These teachings will accommodate other items of information as desired. By one approach, for example, the monitored crop information comprises at least one of the foregoing categories of information. By another approach, as another example, the monitored-cropped information comprises information regarding at least three of the foregoing categories of information. Other combinations are certainly possible.

As already noted above, by one approach the foregoing monitored-crop information is not provided, directly or indirectly, to the farmers themselves. While this information can be provided to the farmers to help better inform their own farming practices, the primary thrust of these teachings is to get this information in a timely and accurate manner to the retailer. Put another way, these teachings are not so much about improving yield or quality as they are about improving the ability of the retailer to react appropriately to likely or actual farming results at the level of the fresh produce display.

In particular, at block 104, this process 100 has the control circuit 201 using the monitored-crop information as derived from the crop-monitoring airborne drone 206 to automatically facilitate changes to a fresh produce display 205 in a retail shopping facility 204. As one simple example in these regards, the control circuit 201 can recommend or mandate making scheduled changes to pricing for one or more items of fresh produce. As a simple example in these regards, when the control circuit 201 determines that a particular item of produce that can be locally provided in a particular timeframe is likely to constitute a bumper crop with more than expected items of produce being available, the control circuit 201 can schedule a price reduction for this particular produce item either before or commensurate with the expected delivery date of that item to the retail shopping facility 204.

As another example in these regards, the control circuit 201 can schedule a change to non-pricing promotional content in the fresh produce display. Presuming the same factual circumstances as are presented in the immediate example above, where the control circuit 201 can determine that a considerable quantity of locally-sourced produce will be likely available at a particular time, the control circuit 201 can schedule the use of posters to be displayed in the fresh produce display 205 that tout the availability of locally-sourced produce. Conversely, when the control circuit 201 determines that only remotely-sourced produce will be likely available in a particular timeframe, the control circuit 201 can schedule taking down any non-pricing promotional materials that tout the availability of locally-sourced produce to coincide with such circumstances.

And as yet another example in these regards, the control circuit 201 can schedule introducing or removing particular non-produce product tie-ins. For example, if a good quantity of good quality apples are expected at a particular time based upon the crop-monitoring information, the control circuit 201 can schedule end caps or other displays in the fresh produce display 205 for non-produce items such as caramel taffy wraps that can be promoted in conjunction with the availability of those apples.

These teachings will accommodate the control circuit 201 using the monitored-crop information in other ways as well. For example, at optional block 105, the control circuit 201 uses the monitored-crop information from the crop-monitoring airborne drone 206 to automatically facilitate ordering produce from at least one alternative product source such as the aforementioned remote resource 208. In this case, that remote resource 208 might comprise an alternative farming operation or a produce warehouse distributor not ordinarily relied upon by the retailer for ordinary day-to-day operations. In particular, by one approach the control circuit 201 can automatically enter an order for a particular quantity of a particular grade of a particular item of produce to be delivered by a particular time to a particular retail shopping facility 204.

As another example in these regards, at optional block 106 the control circuit 201 uses the monitored-crop information from the crop-monitoring airborne drone 206 to automatically facilitate routing produce from the aforementioned distribution center 207 to a particular retail shopping facility 204. As a similar related example in these regards, at optional block 107 the control circuit 201 uses the monitored-crop information from the crop-monitoring airborne drone 206 to automatically facilitate routing produce from another retail shopping facility 204 to a different retail shopping facility 204. This movement of produce can be relatively local (and thereby constitute transporting produce over relatively short distances such as only a few miles) or relatively distant (and thereby constitute transporting produce over a relatively long haul distance such as many hundreds of miles).

These teachings are highly flexible in practice and will accommodate various modifications. As one example in these regards, the aforementioned crop-monitoring information as provided by one or more crop-monitoring airborne drones 206 can be supplemented with other information such as current weather information, predicted weather information, and climate study information as provided by other sources (such as the aforementioned remote sources 208). As another example, the crop-monitoring airborne drone 206 can itself be stationed at the farm in question or can be moved from one farm to another as desired. And as yet another example the crop-monitoring information can include post-harvest data such as information regarding the trucks or trailers being used to move the harvest from the farm, the use or absence of use of appropriate packing crates, boxes, baskets or the like, the duration of time that a harvested crop sits while awaiting transport, and so forth.

So configured these teachings provide the retailer with greatly improved visibility regarding crop performance throughout the growing and harvesting insert cycle without interfering with the farming itself. The retailer can be considerably more proactive with respect to predicting crop performance and automating corresponding responses regarding ordering, scheduling, promoting, pricing, and purchasing.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. An apparatus comprising:
at least one retail shopping facility having a fresh produce display;
a network interface operably coupled to at least one crop-monitoring airborne drone;
a control circuit operably coupled to the network interface and configured to use monitored-crop information from the crop-monitoring airborne drone to automatically facilitate changes to the fresh produce display.

2. The apparatus of claim 1 wherein the changes to the fresh produce display comprise scheduled changes to pricing for fresh produce.

3. The apparatus of claim 1 wherein the changes to the fresh produce display comprise scheduled changes to non-pricing promotional content in the fresh produce display.

4. The apparatus of claim 1 wherein the changes to the fresh produce display comprise at least one of introducing and removing non-produce product tie-ins.

5. The apparatus of claim 1 wherein the control circuit is further configured to use the monitored-crop information from the crop-monitoring airborne drone to automatically facilitate produce ordering from at least one alternative produce source.

6. The apparatus of claim 1 wherein the control circuit is further configured to use the monitored-crop information from the crop-monitoring airborne drone to automatically facilitate routing of produce from a distribution center to the retail shopping facility.

7. The apparatus of claim 1 wherein the control circuit is further configured to use the monitored-crop information from the crop-monitoring airborne drone to automatically facilitate routing of produce from another retail shopping facility to the retail shopping facility.

8. The apparatus of claim 1 wherein the control circuit is further configured to provide information to the crop-monitoring airborne drone via the network interface regarding crop-monitoring geographic boundaries.

9. The apparatus of claim 8 wherein the control circuit is further configured to receive information regarding the crop-monitoring geographic boundaries as sourced by an on-location smartphone.

10. The apparatus of claim 1 wherein the monitored-crop information comprises information regarding at least one of:
crop maturity;
weed infestation;
insect infestation;
a plant disease indicator;
parched conditions;
irrigation status;
land-area yield;
temperature conditions;
conflicting neighboring crops;
post-harvest waste.

11. The apparatus of claim 1 wherein the monitored-crop information comprises information regarding at least three of:
crop maturity;
weed infestation;
insect infestation;
a plant disease indicator;
parched conditions;
irrigation status;
land-area yield;
temperature conditions;
conflicting neighboring crops;
post-harvest waste.

12. A method comprising:
by a control circuit:
receiving monitored-crop information from at least one crop-monitoring airborne drone;
using the monitored-crop information to automatically facilitate changes to a fresh produce display in a retail shopping facility.

13. The method of claim 12 wherein the changes to the fresh produce display comprise scheduled changes to pricing for fresh produce.

14. The method of claim 12 wherein the changes to the fresh produce display comprise scheduled changes to non-pricing promotional content in the fresh produce display.

15. The method of claim 12 further comprising:
using the monitored-crop information from the crop-monitoring airborne drone to automatically facilitate produce ordering from at least one alternative produce source.

16. The method of claim 12 further comprising:
using the monitored-crop information from the crop-monitoring airborne drone to automatically facilitate routing of produce from a distribution center to the retail shopping facility.

17. The method of claim 12 further comprising:
using the monitored-crop information from the crop-monitoring airborne drone to automatically facilitate routing of produce from another retail shopping facility to the retail shopping facility.

18. The method of claim 12 further comprising:
providing information to the crop-monitoring airborne drone regarding crop-monitoring geographic boundaries.

19. The method of claim 18 further comprising:
receiving information regarding the crop-monitoring geographic boundaries as sourced by an on-location smartphone.

20. The method of claim 12 wherein the monitored-crop information comprises information regarding at least one of:
crop maturity;
weed infestation;
insect infestation;
a plant disease indicator;
parched conditions;
irrigation status;
land-area yield;
temperature conditions;
conflicting neighboring crops;
post-harvest waste.
